(19) United States
(12) Patent Application Publication
(10) Pub. No.: US 2024/0314265 A1
(43) Pub. Date: Sep. 19, 2024

(54) Method for Superimposing and Displaying Extra-Information on Image Data for Display on a Display Unit of a Digital Vision System for a Vehicle and Digital Vision System for a Vehicle

(71) Applicant: MEKRA Lang GmbH & Co. KG, Ergersheim (DE)

(72) Inventors: Werner LANG, Ergersheim (DE); Andreas ENZ, Burgbernheim (DE); Sebastian GÖTZ, Würzburg (DE)

(73) Assignee: MEKRA Lang GmbH & Co. KG, (omitted)

(21) Appl. No.: 18/590,295

(22) Filed: Feb. 28, 2024

(30) Foreign Application Priority Data
Mar. 15, 2023 (DE) 102023106451.7

(51) Int. Cl. H04N 5/272; B60K 35/22; B60K 35/28; G06T 3/40; H04N 5/262

(52) U.S. Cl. CPC H04N 5/272; B60K 35/22; B60K 35/28; G06T 3/40; H04N 5/2628; B60K 2360/191; B60K 2360/21

(57) ABSTRACT

Superimposing and displaying extra-information on image data displayed on a display for a vehicle, the system has an image capturing unit having an image sensor, an image processing unit and an image display unit having a display area, and wherein a sensor coordinate system is assigned to the image sensor having an origin of the sensor coordinate system and a scaling of the sensor coordinate system. An extra-information coordinate system is assigned to the extra-information and having an origin and a scaling. The method extracts image data from an extraction area, superimposes extra-information in the image processing unit, and displays image data together with the overlayed extra-information on the image display area of the image display unit. The position of the sensor extraction area is shiftable and/or its size variable.

### BACKGROUND OF THE INVENTION

### 1. Field of the Invention

The invention relates to a method which makes it possible to display extra-information on a display unit of a digital vision system of a vehicle and to a corresponding digital vision system.

### 2. Description of the Related Art

Indirect digital vision systems for vehicles, in particular commercial vehicles, are known and are often also termed camera-monitor-system. Such indirect digital vision systems are used as mirror replacement systems and/or as mirror complementing systems. A mirror replacement system is a camera-monitor-system which replaces mirrors used for displaying legally prescribed fields of view with a camera-monitor-system, such that the vision system replaces the use of the mirror. A mirror complementing system displays regions around a vehicle, for which regions their display is not legally prescribed, and can correspondingly complement a provided mirror or a provided mirror replacement system, i.e. can display regions around the vehicle in addition to the mirror replacement system, which regions are not legally prescribed to be displayed. An example for an indirect digital vision system which is used as a mirror complementing system for passenger cars, is a rear-view camera at the car.

As regards mirror replacement systems, it is legally prescribed that so-called fields of view around a vehicle are visible for the driver when in driving mode. Fields of view are defined areas around a vehicle on a horizontal plane on the ground on which the vehicle is located, which areas must be visible in the mirror or on the mirror replacement system for the driver at all times during the operation of the vehicle. Which fields of view must be visible is dependent on the type of the vehicle, e.g. motorcycles, vehicles for transporting passengers, vehicles for transporting goods, etc. The visibility of the fields of view must be provided by a means for indirect vision and the fields of view must be visible by the driver sitting on the driver's seat using the means for indirect vision at all times. Depending on the type of the vehicle and, in particular, depending on which areas around the vehicle are directly visible by the driver, different legal regulations require that specific fields of view are always and permanently and reliably visible, using the means for indirect vision. In Europe, the respective fields of view which have to be always reliably visible for the driver, are defined by UN/ECE regulation No. 46. Further relevant provisions and regulations include, for example, ISO5721, ISO 5006, ISO 16505, ISO14401 and EU 167/2013.

Generally, both areas legally prescribed to be visible as well as additional areas, which are made visible by means of indirect vision systems, are termed view area. Correspondingly, view areas may comprise legally prescribed fields of view. For the representation of the view areas, it has recently become more and more popular to consider using camera systems as a means for indirect vision either in addition or as a replacement for the mirrors, especially because the flexibility for capturing regions around the vehicle is increased with respect to conventional mirrors and, e.g. dead angle areas can be minimized. Further, even though the distortion inherent to mirrors is not completely eliminated, it can be shifted more easily into areas which are of less importance for the driver.

In such digital vision systems, which are also called camera-monitor-systems, an image capturing unit continuously captures and determines an image and/or processes (edits) the image and possibly saves it. The (video) data captured by an image capturing unit is further forwarded and provided to a display device or an image display unit in the driver's cabin, e.g. using an image processing unit. The image display unit shows a view of the corresponding view area, e.g. comprising a legally prescribed field of view or multiple fields of view, in a manner that the fields of view are always permanently visible for the driver, if required.

Permanently visible means with respect to mirror replacement systems that the view of a field of view is represented in a timely uninterrupted manner, i.e. is not interrupted by intermittent showing and hiding the field of view or parts thereof, or by superimposing other representations such that the field of view is not completely visible. Accordingly, the respective field of view or the respective fields of view can be shown continuously and in real time and can be made visible, respectively. This at least holds for fields of view prescribed to be permanently visible for all vehicle conditions in which the ignition switch is switched on and/or preferably coupled with e.g. a sensor receiving a corresponding signal, e.g. a door opening signal or an ignition switch-on signal. There are particular, usually timely limited, driving conditions in which it can be sometimes allowed to temporarily not show the respective legally prescribed field of view or to temporarily show it only partially, i.e. to show a sub-portion of the field of view.

The image capturing devices (cameras) of the digital vision systems have one or a plurality of image sensors onto which a captured image is mapped. It is known to extract image parts at different positions of the image sensor, depending on the desired representation, and to provide them to the image display unit of the vision system after processing in the image processing unit. For example, a different area on the side of the vehicle can be extracted from the image sensor and can be displayed on the image display unit, when driving around a corner than when driving forward.

Further, it is known to superimpose extra-information on the displayed image of the fields of view and/or view areas. Such optional additional information can be, e.g., collision risks, distances to other vehicles, distances to other objects etc. for the region around the vehicle, traffic signs and signalizations and much more. Either such extra-information can be retrieved from a memory of the vision system, because it is stored there, or it can be obtained by e.g. image recognition and then superimposed on the displayed image, as, e.g. highlighting of collision objects around the vehicle. The known overlay of extra-information retrievable from a memory takes place at always the same location and position on the image display unit, i.e. the extra-information is, based on a coordinate-system related to the image display unit, always visible the same location. Accordingly, the overlay is independent of e.g. the zoom factor of the image shown behind the overlay, of the extraction position on the image sensor etc. always positioned at the same position of the image display unit. This procedure is not problematic as long as the extra-information refers to information independent of the vehicle, as e.g. traffic information like speed limits, and as long as this information is superimposed and displayed such that it does not hide legally prescribed fields of view, because the continuous and permanent view of these fields of view would no longer be provided. However, information which has a fixed position with respect to the vehicle, as e.g. distance lines with respect to the vehicle, cannot be always correctly displayed. For example, when the extraction position on the image sensor changes or the zoom (magnification) factor of the representation on the image display unit changes, this information is not at a correct and accurate position with regard to the vehicle on the image. Thus, such information is hidden and no longer displayed upon such a change of the represented image section, i.e. it is only shown in a basic (default) setting of the representation. Accordingly, it is not provided to the driver in all driving conditions and driving situations.

### SUMMARY OF THE INVENTION

It is an object of the invention to provide a method for superimposing and visualizing extra-information onto image data which is displayed on an image display unit of a digital vision system of a vehicle, which method is suitable for displaying information having a fixed position with respect to the vehicle in an easy and correct manner, independently from changes of the displayed image section or the magnification level (zoom). Additionally, a corresponding digital vision system is provided.

This object is solved with a method comprising the features of claim 1 and a system comprising the features of claim 9. Preferred embodiments are defined in the dependent claims.

The invention is based on the idea to provide a method and a system with which extra-information having a fixed positional relationship to the vehicle and/or being retrievable from a memory can be visualized on the displayed image in a correct position in an easy manner and particularly without image recognition techniques, even if the displayed area around the vehicle changes, i.e. if the portion which is extracted from the image capturing unit and in particular from the image sensor of the image capturing unit changes. For this purpose, a coordinate system is respectively assigned to the extra-information and the image sensor, and the two coordinate systems have fixed ratios with respect to their scaling, their origins, and their orientations. Because the coordinate system assigned to the image sensor has a known position and orientation with respect to the vehicle, the extra-information, particularly its coordinate system, can be allocated to specific locations and magnification levels of the sensor coordinate system and, thus, overlayed at a correct position, in an easy manner with the help of and using the known and fixed ratios of the coordinate systems. Accordingly, the computational power for superimposing the extra-information at the correct position is minimal and extra-information, which has a fixed position with respect to the vehicle, can be displayed at the correct position without huge expenditure, even if a digital adjustment of, for example, the angle of vision takes place.

The sensor coordinate system having a fixed position with respect to the extra-information coordinate system means that the point of origin of the extra-information coordinate system is assigned to a defined point within the sensor coordinate system. In particular, the points of origin of both coordinate systems may coincide, for example, i.e. the point of origin of the extra-information coordinate system is at the point of origin of the sensor coordinate system. Alternatively, the point of origin of the extra-information coordinate system can be at a different, fixed point of the sensor coordinate system. This correspondingly holds for the coordinate axes of both coordinate systems, i.e. the orientation of the coordinate systems, which might either coincide (the x-axes and the y-axes are in parallel, respectively, with a cartesian coordinate system) or have a fixed angular ratio. Scaling of the sensor coordinate system and the extra-information coordinate system refers to their units, respectively, i.e. for having a fixed ratio, one unit of the sensor coordinate system corresponds to a defined number m of units of the extra-information coordinate system along each of the coordinate axes, respectively, i.e. the ratio of scaling of the sensor coordinate system to the scaling of the extra-information coordinate system is 1:m and remains constant.

A method for superimposing and displaying of extra-information on the image data is provided, which image data is displayed on an image display unit of a digital vision system of a vehicle, wherein the vision system comprises an image capturing unit having an image sensor, an image processing unit and an image display unit having an image display area. A sensor coordinate system having a sensor coordinate system origin and a sensor coordinate system scaling is assigned to the image sensor, and an extra-information coordinate system having an extra-information coordinate system origin and an extra-information coordinate system scaling is assigned to the extra-information. Thus, the method then comprises the steps of extracting image data from an sensor extraction area of the image sensor, of superimposing the extra-information on the extracted image data in the image processing unit, and of displaying the image data together with the superimposed extra-information on the image display area of the image display unit, wherein the position of the sensor extraction area in the sensor coordinate system can be shifted and/or the size of the sensor extraction area is variable. The extra-information is superimposed on the extracted image data such that, independently of a shift of the position of the sensor extraction area and/or of a change of the size of the sensor extraction area, the origin of the extra-information coordinate system is allocated to a fixed point in the sensor coordinate system, the orientation of the extra-information coordinate system with respect to the sensor coordinate system is fixed, and the ration of the scaling of the extra-information coordinate system to the sensor coordinate system is in a fixed ration m:1.

The digital vision system is correspondingly adapted for extracting image data at different positions from an image sensor, the image sensor having a known position with respect to the vehicle, and/or for displaying image data having different magnification levels on the image display unit, i.e. different positions of the sensor extraction area on the image sensor and/or different sizes of the extracted area on the image sensor correspond to the image displayed on the image display unit. This means that the digital vision system is adapted for extracting the data at different positions of the image sensor. Accordingly, using a single image capturing unit, on the one hand e.g. different views can be extracted using digital means, which can either be displayed simultaneously or in dependence of a driving situation, e.g. images corresponding to a wide angle mirror of a commercial vehicle and a main mirror of a commercial vehicle, and, on the other hand, a pivot or a shift of the image capturing unit can be imitated in a digital manner.

According to a preferred embodiment the sensor coordinate system and the extra-information coordinate system are cartesian coordinate systems, respectively, having an x-axis and an y-axis, respectively, and the ratio of the scaling of the x-axis of the extra-information coordinate system to the scaling of the x-axis of the sensor coordinate system is in a fixed ratio m₁:1, and the ratio of the scaling of the y-axis of the extra-information coordinate system to the scaling of the y-axis of the sensor coordinate system is in a fixed ratio m₂:1. In other words, the scaling in one spatial direction (x-axis direction) of the two coordinate systems can have a first fixed ratio and in a second spatial direction (y-axis direction) a second fixed ratio, wherein the first fixed ratio and the second fixed ratio are preferably identical, but do not necessarily have to be identical.

In one embodiment, the image capture unit and/or the image sensor are mechanically adjustable, such that there is a component of movement parallel to an image level of the image sensor or that there is a component of movement corresponding to a shift in the sensor coordinate system upon adjustment. Upon a mechanical adjustment of the image capturing unit and/or the image sensor having a movement direction component parallel to an image level of the image sensor and an adjustment having a movement direction component corresponding to a shift in the sensor coordinate system, respectively, along a movement distance, the extra-information is superimposed on the extracted image data such that the position of the origin of the extra-information coordinate system is shifted corresponding to the movement distance in the sensor coordinate system and with respect to the fixed point in the sensor coordinate system, respectively.

In this case, the position of the image sensor with respect to the vehicle is changeable, for example by tiltable mounting the camera on the vehicle, e.g. for providing vision to different regions around the vehicle, or by providing the camera translationally displaceable using e.g. a stepper motor. It is essential in this case that the position of the image sensor in the starting position and the position of the image sensor in the displaced position is known relative to the vehicle. In this manner an image comprising extra-information which is at a fixed position relative to the vehicle can be overlayed on an image captured by the camera and the image sensor for the driver without huge expenditure, also when tiltable camera arrangements or displaceable camera arrangements are used. Means for displacing for the digital vision system are e.g. a telescopic arm, a rotational means by means of a folding gearbox of an arm to which the image capturing unit is mounted.

Generally, it is also possible to provide an optic of the image capturing unit with respect to an optical magnification factor in a mechanically adjustable or changeable manner, wherein a mechanical adjustment of the optical magnification factor of the image capturing unit the extra-information is superimposed on the extracted image data such that the magnification (zoom) of the extra-information coordinate system with respect to the sensor coordinate system compensates for the optical magnification factor of the image capturing unit.

Generally, it is also possible to only provide a mechanical adjustment of the image capture unit, without a digital shift or change of the sensor extraction area regarding the size and position of the image.

According to a preferred embodiment, the extra-information is saved in the image processing unit as a defined, fixed graphics, text or vector graphics. For example, the extra-information having a fixed positional relationship with respect to the vehicle can be distance lines behind or at the side of the vehicle. A fixed defined graphic is a graphic which is stored and saved in the digital vision system. A fixed defined graphic can also be defined by the driver to the extent that he e.g. decides on the distance to the vehicle in which distance lines should be shown prior to starting driving or whether the unit of the distance should be shown, as well, or not. Preferably, the extra-information is stored as a transparent fixed defined graphics, which has the advantage that an overlay does not completely hide the image information, but the image information remains visible. Alternatively, the fixed defined graphics might be opaque or only partially transparent.

A particularly preferred extra-information regarding the vehicle is any information which is stationary with respect to the vehicle in all driving situations, in particular distance lines relative to the vehicle. For example, the extra-information may comprise distance lines behind the vehicle, at distances of e.g. 30 m, 50 m etc. behind the vehicle, a line adjustable by the driver for marking the end of the vehicle or of a trailer etc.

In a preferred embodiment the method further comprises the step of changing the position and/or size of the sensor extraction area. This can, e.g., be triggered by an input from the driver or a sensor signal, e.g. a sensor which indicates the start of a turning movement (e.g. setting an indicator). For example, the driver can control a change of the view area and/or the viewing angle, a change of the magnification factor (zoom) by means of a user input on a control panel. A further example for an automatic change which is depending on a sensor signal, is trailer panning, i.e. the automatic tracking of the trailer. The adjustment of the selection of the sensor extraction area can also be achieved by a suitable factory setting or workshop setting.

Preferably, the method further comprises the step of scaling the image data and/or of the extra-information for display on the image display unit. This means that the image data extracted from the image sensor and/or the extra information are scaled before visualization on the image display unit. In this case, the ratio between the scaling of the sensor coordinate system and the scaling of the extra-information coordinate system remains unchanged. This serves for example for realizing a particular desired zoom or for adjusting the representation to the size of the image display unit, e.g. a monitor. For example, if the size and scaling of the extra-information coordinate system is adjusted to the size of the image display unit, e.g. a monitor, (1:1 scaling) and the ration between the scaling of the sensor coordinate system and the scaling of the extra-information coordinate system is e.g. 1:m, the ration 1:m is kept unchanged if the image data and the extra-information are enlarged or reduced, i.e. scaled, for visualization on the image display unit, and only the scaling between the sensor coordinate system and the representation on the image display unit and the scaling between the extra-information coordinate system and the representation on the image display unit are changed.

In a preferred embodiment, further a step of selecting a partial quantity of the data of the extra-information for display on the image display unit is provided. If, for example, distance lines are to be overlayed as extra-information, for example only a sub-portion of the extra-information can be selected for display, i.e. a section of the length of the distance lines, for example, for avoiding unnecessarily covering image areas. The partial quantity can be selected in dependence of, e.g., the driving situation, e.g. straight forward driving or turning, e.g. for avoiding covering the fields of view, or it can be selected dependent on driver settings, workshop settings or factory settings, e.g. whether a driver wishes to have distance lines each 20 meters or 50 meters. The partial quantity of date of the extra-information, i.e. the area of the extra information which is overlaid, for example, can be dependent on the sensor extraction area and can be variable as regards its extension, depending on where the sensor extraction area is located. Alternatively or additionally the partial quantity of data may refer to particular selected information, e.g. only distance lines, only traffic information etc., depending on specific driving situations and/or the active sensor extraction area.

A digital viewing system for a vehicle comprises an image capturing unit having an image sensor, an image processing unit and an image display unit with an image display area, wherein a sensor coordinate system having a sensor coordinate system origin and a sensor coordinate system scaling is allocated to the image sensor, and an extra-information coordinate system having an extra-information coordinate system origin and an extra-information coordinate system scaling is allocated to the extra-information. The image viewing system is adapted to extract image data from different areas as regards their size and/or position from the image sensor and to display on the image display unit in the image display area, respectively, and to carry out the method described above. The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention is described by way of example using the accompanying figures, in which:

FIG. 1 schematically shows a digital vision system for a vehicle;

FIG. 2 schematically shows a relationship between an image sensor, an extra-information and an image display area with corresponding coordinate systems according to a first embodiment of the invention;

FIG. 3 schematically shows a relationship between an image sensor, an extra-information and an image display area with corresponding coordinate systems according to a second embodiment of the invention;

FIG. 4 shows a first example for a visualization on and image display area in a default setting;

FIG. 5 shows a shifted view of the example of FIG. 4;

FIG. 6 shows a further shifted view of the example of FIG. 4;

FIG. 7 shows a second example for a visualization on and image display area in a default setting; and

FIG. 8 shows a shifted view of the example of FIG. 7.

### DETAILED DESCRIPTION OF THE DISCLOSED EMBODIMENTS

Embodiments of the invention are described in the following in detail based on the attached figures. It is to be noted that details of the respective embodiments can be combined with other embodiments, even if not explicitly mentioned in the following.

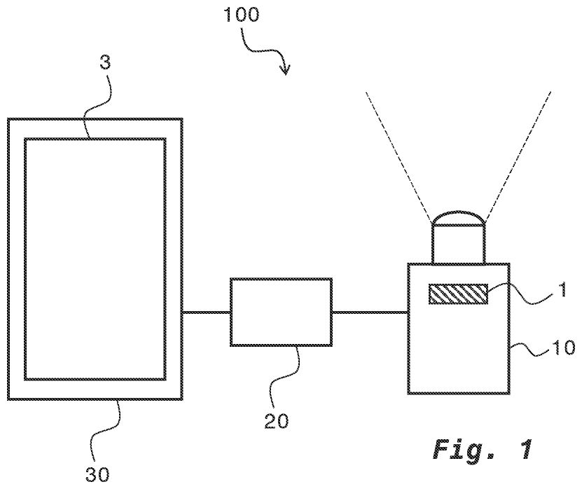

FIG. 1 schematically shows a digital vision system 100 according to the invention. The digital vision system 100 comprises an image capturing unit 10 having an image sensor 1, an image processing unit 20 and an image display unit 30 having an image display area 3. The image display unit 30 can be a monitor, for example, wherein an image captured by a camera forming the image capturing unit 10 can be displayed on the image display area 3 of the monitor. The image processing unit 20 can be formed as a separate unit, can be provided by means of a general board computer, or can be integrated in the image capturing unit 10 or the image display unit 30.

The image capturing unit 10 is provided on a vehicle (not shown) such that the position and orientation of the image capturing unit 10 having the image sensor 1 is known with respect to the vehicle in a default position, such that the position and orientation of the region mapped on the image sensor 1 and which is captured with the image capturing unit 10 are determined.

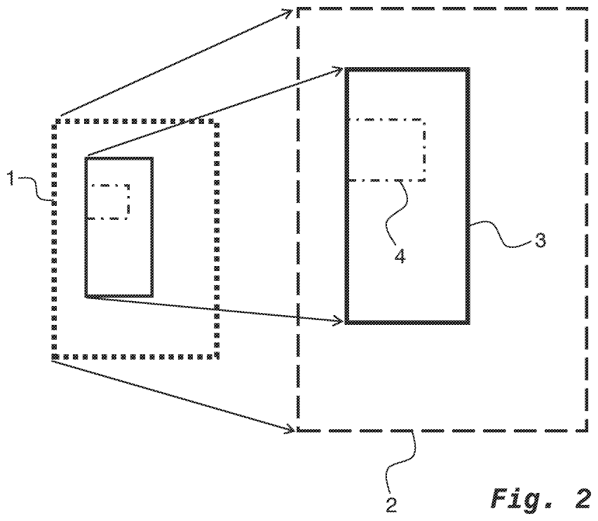

FIG. 2 schematically shows the connection between the image sensor 1 and an extra-information 4, which is to be superimposed onto an image to be displayed on the image display area 3 of the image display unit 30, including their corresponding coordinate systems according to a first embodiment.

A sensor coordinate system 1-1 is assigned to the image sensor 1, which is a cartesian coordinate system having an origin 1-0 of the sensor coordinate system, a x-axis 1-2 and a y-axis 1-3 of the sensor coordinate system. Further, the sensor coordinate system 1-1 comprises a scaling of the sensor coordinate system in x-axis direction and in y-axis direction, i.e. one unit of the sensor coordinate system is assigned to a defined distance on the image sensor 1.

A cartesian coordinate system is assigned as an extra-information coordinate system 4-1 to the extra-information 4, as well. In FIG. 2, the extra-information coordinate system is depicted in the representation of the image sensor 2 for illustration purposes. The extra-information coordinate system 4-1 has an origin 4-0 of the extra-information coordinate system, a x-axis 4-2 and a y-axis 4-3 of the extra-information coordinate system. In addition, the extra-information coordinate system 4-1 has a scaling of the extra-information coordinate system in x-axis direction and in y-axis direction, i.e. one unit of the extra-information coordinate system is assigned to a defined distance of the extra-information 4. The scaling in x-axis direction and the scaling in y-axis direction are identical, respectively, which, however, need not necessarily always be the case.

The scaling of the extra-information coordinate system 4-1 may correspond to that of the sensor coordinate system 1-1, i.e. a certain distance on the image sensor 1 corresponds to an identical distance of the extra-information 4, such that the ratio of the scaling of the extra-information coordinate system 4-1 to the scaling of the sensor coordinate system 1-1 is 1:1. In general, the ratio of the scaling of the extra-information coordinate system 4-1 to the scaling of the sensor coordinate system 1-1 may be m:1, i.e. m units of the extra-information coordinate system 4-1 correspond to one unit of the sensor coordinate system 1-1.

As can be seen in FIG. 2, the origin 4-0 of the schematically depicted extra-information coordinate system 4-1 is assigned to a certain position of the sensor coordinate system 1-1 and the orientations of the x- and y-axes of the extra-information coordinate system 4-1 and the sensor coordinate system 1-1 are identical. Alternatively, the origin 1-0 of the sensor coordinate system 1-1 and the origin 4-0 of the extra-information coordinate system can coincide.

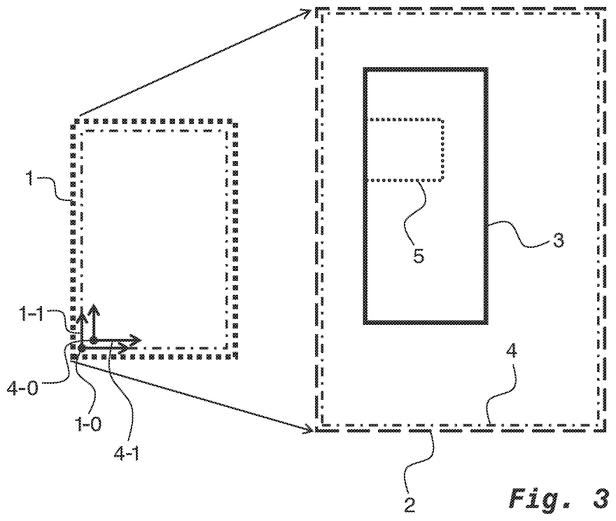

The extra-information 4 can be provided for only a sub-portion of the region which can be captured with the image sensor 1, as shown in FIG. 2, or it can be provided for the entirety of the region which can be captured with the image sensor, as shown in FIG. 3.

The extra-information 4 is information which is provided for at least a sub-portion of the image sensor and is preferably provided as a fixed graphics which can be superimposed and overlayed, respectively, on the image to be shown on the image display area 3 and usually comprises information stationary with respect to and regarding the vehicle, as, e.g. distance lines or distance markers.

FIG. 2 further shows the image display area 3 and the extra-information 4 which is schematically shown on the image display area 3. Extra-information 4 is only provided for the area shown and the extra-information is shown as a whole, i.e. not only a sub-portion of the extra-information is displayed.

In the embodiment shown in FIG. 3, to the contrary, of the extra-information 4 only a displayed portion 5 of the extra-information 4 is displayed, i.e. depending on specific conditions only a sub-portion of the extra-information 4 is displayed on the image display area 3. This means that only a partial quantity of the available data of the extra-information is selected for display and displayed. The conditions according to which this partial quantity is selected, can be, e.g. the position of the sensor extraction area 3-1, a driving condition, a combination thereof or a partial quantity of the extra-information selected according to e.g. the preferences of the driver or a partial quantity of the available data of the extra-information predetermined by the factory or workshop.

Except for the differences described the embodiments according to FIG. 2 and FIG. 3 are identical. Further, a scaling (here magnification) of the image data provided on the image sensor 1 before display on the image display unit 30 (the image display area 3) is shown in FIGS. 2 and 3. This means that the image data existing on the image sensor 1 is firstly magnified such that a fictitious image display area 2 results, in the embodiment of FIG. 2, which fictitious image display area 2 corresponds to the image sensor 1 as regards the image information existing thereon and which corresponds to the representation on the image display unit 30, in particular the image display area 3, as regards the desired scale (e.g. magnification). In the embodiment shown in FIG. 3, the extra-information 4 exists on the entire fictious image display area 2, which is suggested by dash-dot lines.

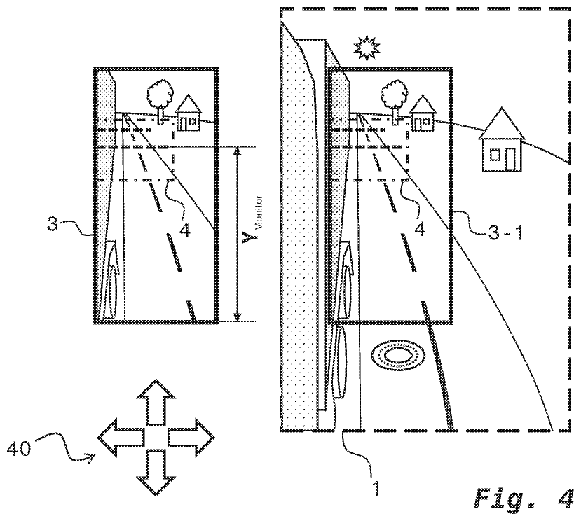

FIGS. 4 to 6 illustrate a first example of a method for displaying extra-information 4.

In FIG. 4 an image display unit 30 comprising an image display area 3 is shown on the left hand side, the related image sensor 1 comprising image data is shown schematically on the right hand side. A sensor extraction portion 3-1 is also shown on the image sensor 1. This sensor extraction portion 3-1 can correspond to that what the image processing unit 20 actually extracts from the image sensor 1 in a respective situation, or the whole image can always exist in the image processing unit 20 and the image processing unit 20 extracts the respective sensor extraction area 3-1 for display on the image display area 3.

FIG. 4 further shows the extra-information 4 on the image sensor 1, which exists in a sub-portion of the image sensor 1 and also in a sub-portion of the sensor extraction area 3-1.

In the default position shown in FIG. 4, in which the driver has not operated the operation switch 40 for digital shifting of the sensor extraction area 3-1, i.e. in a standard or default position, the distance lines, which are a fixed graphics forming extra-information, are shown on a certain position which is correct as regards the relative position with respect to the vehicle. For this purpose the extra-information 4 is superimposed on the image data from the image sensor 1 such that the origin 4-0 of the extra-information coordinate system 4-1 lies at a fixed point of the sensor coordinate system 1-1, and the x-axes and y-axes of the coordinate systems have a specific orientation with respect to each other and the ratio of the scaling of the extra-information coordinate system 4-1 with respect to the scaling of the sensor coordinate system 1-1 is m:1, wherein m is a certain number.

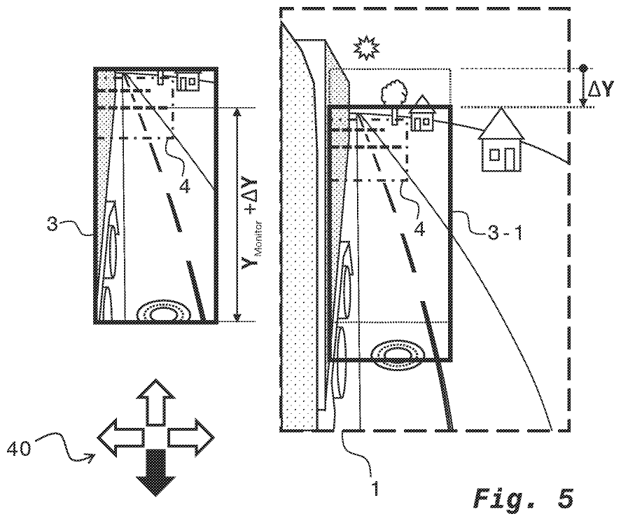

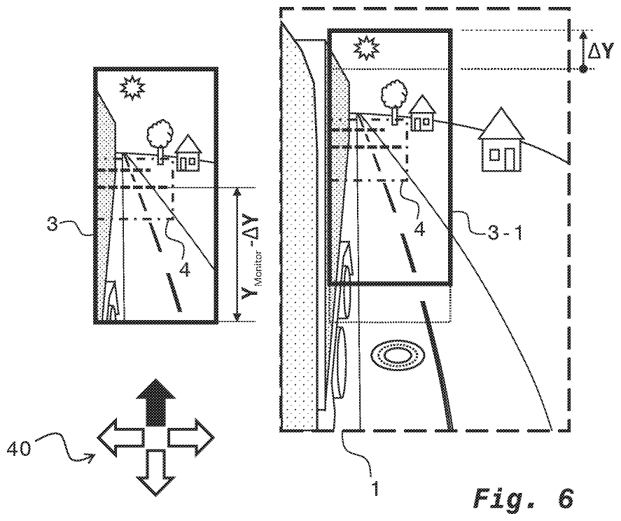

When the driver operates the operation switch 40 for digitally shifting the sensor extraction area 3-1 as schematically shown in FIGS. 5 and 6, the sensor extraction area 3-1 shifts on the image sensor 1. Because the origin 4-0 of the extra-information coordinate system 4-1 is at a specific point of the sensor coordinate system 1-1, the x-axes and y-axes of the coordinate systems have a specific orientation and the ratio of the scaling of the extra-information coordinate system 4-1 to the scaling of the sensor coordinate system 1-1 is m:1, wherein m represents a specific number, and because these are kept when changing the sensor extraction area 3-1, the extra-information 4 is displayed at the correct position relative to the vehicle even if the sensor extraction area 3-1 is digitally shifted, as it is shown in FIGS. 5 and 6.

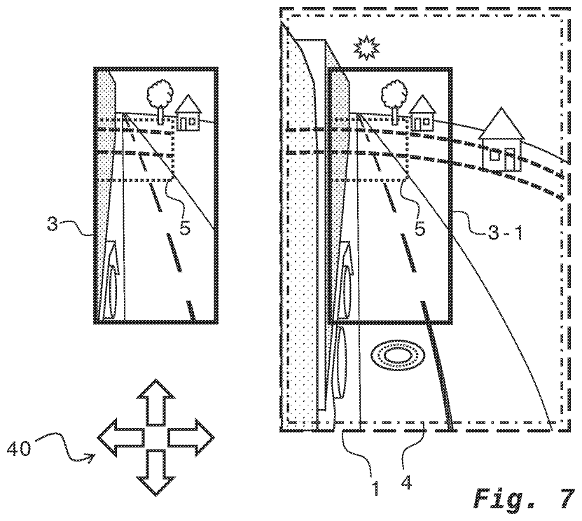

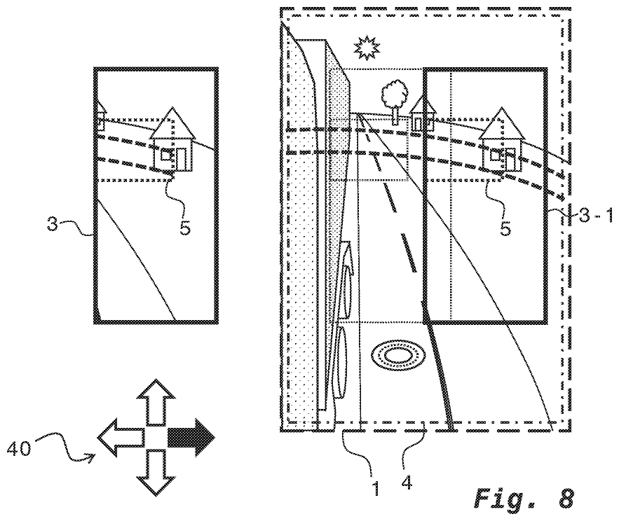

FIGS. 7 and 8 show a second example of a default position and a digitally shifted position with respect to the default position of the sensor extraction area 3-1. Different from the example described in combination with FIGS. 4 to 6, not the whole extra-information 4, which exists for the entire area of the image sensor 1, is shown on the image display area 3, but only part thereof in the example shown in FIGS. 7 and 8. I.e. only a selected, displayed portion 5 of the extra-information 4 is shown on the image display area 3. The selection which portion 5 of the extra-information is displayed can be made depending on the fields of view displayed, which should not be covered, or optical considerations or with regard to clarity. Apart thereof, this example corresponds to the example described in connection with figures t to 6.

Instead of an operation of a operation switch 40, a digital shift or a zoom (magnification/reduction) might also be triggered by a sensor signal from a vehicle sensor.

Further, instead of the digital shift or the digital magnification, or in addition thereto, a mechanical adjustment can be carried out, e.g. by translational movement of the camera comprising the image sensor for a certain distance by means of a step motor, by tilting the camera and/or by mechanically adjusting the optics of the image capturing unit, wherein, however, the distance of the translational movement or the tilting angle of the magnification are known. The extra-information can be shifted or changed correspondingly in this case.

In any case, it is not necessary to carry out complex calculations of the exact position for displaying extra-information or to have image recognition, but the extra-information can always be placed in the displayed image at the correct position by simple translational movement and/or magnification.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for superimposing and displaying of extra-information on image data displayed on an image display unit of a digital vision system for a vehicle, the vision system comprises an image capturing unit having an image sensor, an image processing unit and an image display unit having and image display area, a sensor coordinate system is assigned to the image sensor, the sensor coordinate system has an origin of the sensor coordinate system and a scaling of the sensor coordinate system, an extra-information coordinate system is assigned to the extra-information, and the extra-information coordinate system has an origin of the extra-information coordinate system and a scaling of the extra-information coordinate system, the method comprising:
extracting image data from an extraction area of the image sensor;
superimposing the extra-information on the extracted image data in the image processing unit; and
displaying the image data together with the overlayed extra-information on the image display area of the image display unit,
wherein the position of the sensor extraction area in the sensor coordinate system is shiftable and/or the size of the sensor extraction area is variable,
wherein the extra-information is superimposed on the extracted image data such that the origin of the extra-information coordinate system is assigned to a fixed point in the sensor coordinate system, and
wherein the orientation of the extra-information coordinate system is fixed with respect to the sensor coordinate system, and the ratio of the scaling of the extra-information coordinate system to the scaling of the sensor coordinate system is affixed a ratio m:1, independent of a shifting of the position of the sensor extraction area and/or a change of size of the sensor extraction area.

2. The method according to claim 1, wherein the sensor coordinate system and the extra-information coordinate system are cartesian coordinate systems having an x-axis and an y-axis, respectively, and the ratio of the scaling of the x-axis of the extra-information coordinate system to the scaling of the x-axis of the sensor coordinate system is a fixed ration m₁:1, and the ratio of the scaling of the y-axis of the extra-information coordinate system to the scaling of the y-axis of the sensor coordinate system is a fixed ration m₂:1.

3. The method according to claim 1, wherein the image capturing unit and/or the image sensor are mechanically adjustable, such that an adjustment directional movement component results, which corresponds to a shift in the sensor coordinate system,
wherein upon a mechanical adjustment of the image capturing unit and/or the image sensor having an adjustment directional movement component corresponding to a shift in the sensor coordinate system and by a movement distance, the extra-information is superimposed such on the extracted image data that the position of the origin of the extra-information coordinate system is shifted corresponds to the movement distance in the sensor coordinate system with respect to the fixed point in the sensor coordinate system.

4. The method according to claim 1, wherein the extra-information is stored in the image processing unit as a fixed defined graphics.

5. The method according to claim 4, wherein the extra-information comprises information which is stationary with respect to the vehicle, in particular distance information regarding the vehicle.

6. The method according to any claim 1, further comprising changing the position and/or size of the sensor extraction area.

7. The method according to claim 1, further comprising scaling the image data and/or the extra-information for display on the image display unit.

8. The method according to claim 1, further comprising selecting a partial quantity of the extra-information data for display on the image display unit.

9. A digital vision system for a vehicle comprising an image capturing unit having an image sensor, an image processing unit, and an image display unit having an image display area,
wherein a sensor coordinate system is assigned to the image sensor, the sensor coordinate system having an origin (1-0) of the sensor coordinate system and a sensor coordinate system scaling,
extra-information for superimposing and displaying on image data shown on the image display unit is provided, and an extra-information coordinate system is assigned to the extra-information, the extra-information coordinate system having an origin (4-0) of the extra-information coordinate system and an extra-information coordinate system scaling,
wherein the digital vision system is adapted to carry out the method according to claim 1.
